(19) United States
(12) Patent Application Publication
(10) Pub. No.: US 2016/0275620 A1
(43) Pub. Date: Sep. 22, 2016

(54) SYSTEM AND METHOD FOR AUCTION-BASED TRANSFER OF FINANCIAL INSTRUMENTS

(71) Applicants: Juan M. Hernandez, Chicago, IL (US); Jordan Fishfeld, Chicago, IL (US)

(72) Inventors: Juan M. Hernandez, Chicago, IL (US); Jordan Fishfeld, Chicago, IL (US)

(73) Assignee: CF Innovations Group Inc., Chicago, IL (US)

(21) Appl. No.: 15/075,915

(22) Filed: Mar. 21, 2016

Related U.S. Application Data
(60) Provisional application No. 62/135,789, filed on Mar. 20, 2015.

(51) Int. Cl. G06Q 40/06; G06Q 40/04

(52) U.S. Cl. CPC G06Q 40/06; G06Q 40/04

(57) ABSTRACT

System and methods for trading and managing special purpose contracts of privately held assets via crowdfunding portals. The invention includes creating financial instruments for use by approved parties involving equity ownership, debt obligations or revenue sharing agreements of an underlying hard asset/business. The instruments are sold to approved/certified buyers who desire the contracts for ownership and economic interest. Intrinsic contract value is determined by terms of the agreement, revenue stream from the underlying asset, and time period remaining in the contract. The computer-based trading system receives buy and sell orders for the derivative financial instruments from a plurality of client computers. The server computer matches the buy orders to the sell orders and manages ownership interest via an asset exchange and management program executed by the server computer. The system manages disbursement of profits, dividends and other revenue to the contract owners via the asset exchange and management system.

### CROSS-REFERENCE TO RELATED APPLICATIONS

This nonprovisional application is a continuation of and claims priority to U.S. Provisional Patent Application Ser. No. 62/135,789, entitled “System And Method for Auction-Based Transfer of Financial Instruments”, filed Mar. 20, 2015 by the same inventors, the entirety of which is incorporated herein by reference.

### BACKGROUND OF THE INVENTION

1. Field of the Invention

This invention relates, generally, to computer-based trading of privately-held assets and other financial instruments. More specifically, it relates to systems and methods providing a computerized exchange market of private offerings of special purpose vehicles/contracts or crowd-financed assets, which are based on underlying financial instruments and in which a plurality of investors can buy and sell economic interest in the corresponding financial instruments.

2. Brief Description of the Prior Art

Although recent legislative changes have allowed for general solicitation of funds for private investment offerings, there is no uniform standard or system for these private assets that facilitates and allows for the ability to buy, sell or otherwise trade and value these assets amongst each other.

Exchanges for trading climate credits (see U.S. Pat. Nos. 7,343,341 to Sandor et al. and 7,734,531 to Sandor et al.) and for trading virtual assets (see U.S. Pat. No. 5,950,176 to Keiser et al.) are known in the art, along with general crowdfunding offering technology, such as U.S. Patent Application Publication Nos. 2014/0164291 to Cameron et al., 2014/0012780 to Sanders, and 2014/0279682 to Feldman. However, the conventional art is ineffective for crowdfunding contracts/assets, in particular that provide secondary market capabilities, such as the ability to properly value contracts regardless of their underlying asset and financial instrument type.

Accordingly, what is needed is an exchange process and platform that provide a standardized uniform contract (special purpose vehicle or crowd-funded asset) necessary to allow for these secondary market capabilities, and exchange (e.g., buy, sell, trade, value, manage, etc.) this type of contract. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an effective system and computer-based method for trading and managing contracts issued via crowdfunding portals is now met by a new, useful, and nonobvious invention.

In an embodiment, the current invention is a system and method for trading special purpose contracts of privately held assets. The invention can be broken down into two components or steps. The first component or step involves the creation of a crowd-financed asset (CFA) or a special purpose vehicle (SPV) that standardizes an interface and details explicitly the economic interest a shareholder of said vehicle has within an underlying privately held asset. The CFA/SPV has three roles/owners, the sponsor that controls the underlying asset, the issuer that defines the terms and relationship of the CFA/SPV, and the investors/limited partners who can purchase a membership interest in the CFA/SPV for the purpose of economic interest and capital investment. The CFA/SPV has a standardized interface with required methods for specific behaviors and attributes (to be defined by CFIG). While underlying terms and relationships may vary per CFA/SPV, the common framework allows for a clear comparison of different CFAs/SPVs regardless of the underlying asset. Underlying asset may be a private business, a private building trust, or some other kind of private asset with varying economic yields. The CFA/SPV owns economic interest in the underlying asset and has rights and responsibilities as defined between the sponsor and issuer. The nature of economic interest can vary in instrument type, ranging from equity, preferred equity, mezzanine debt, senior debt, or revenue sharing agreements.

The second component or step defines a system and method for trading these CFAs/SPVs, ranging from initial offering methods from a sponsor and issuer to a multitude of qualified investors (including individual and institutional entities), valuation methodologies, buying and selling capabilities between private parties using a third party intermediary as an exchange and escrow entity, the process for defining transfer of ownership between private parties of these CFAs/SPVs (including investor accreditation to determine suitability, authorized signatures of subscription agreements and transfer documents, secured ACH transfer into authenticated escrow accounts or via the use of an authorized margin account maintained with the issuer, and the settlement and clearing process for the entirety of the document bundle and authorizations).

An object of the current invention is to allow for and facilitate the trade of privately held assets through the use of standardized uniform contracts that clearly delineate behavior and characteristics needed to properly value, track, manage and transfer ownership status to other private qualified parties.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a flow diagram of an asset exchange system, according to an embodiment of the current invention.

FIG. 2 is a network diagram of an asset exchange server, according to an embodiment of the current invention.

FIG. 3 is an asset exchange diagram, according to an embodiment of the current invention.

FIG. 4A is a flowchart depicting creation of a special purpose vehicle or crowd-funded asset, according to an embodiment of the current invention.

FIG. 4B is a flowchart depicting initiation and completion of a successful transaction, according to an embodiment of the current invention.

FIG. 4C is a flowchart depicting accounting, reporting, and distributions, according to an embodiment of the current invention.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

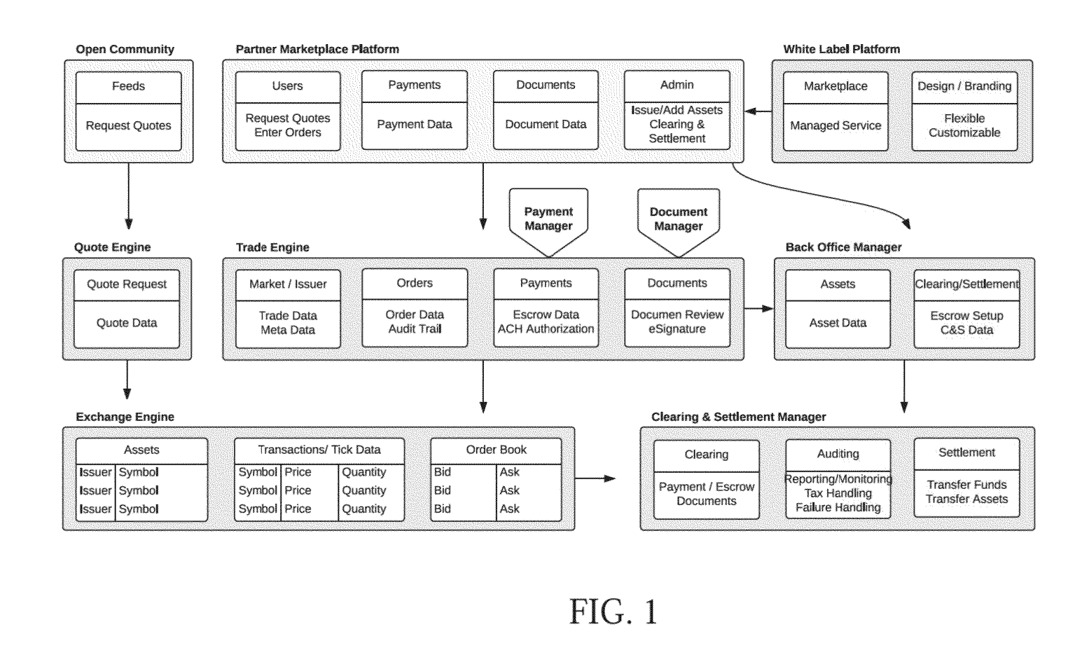

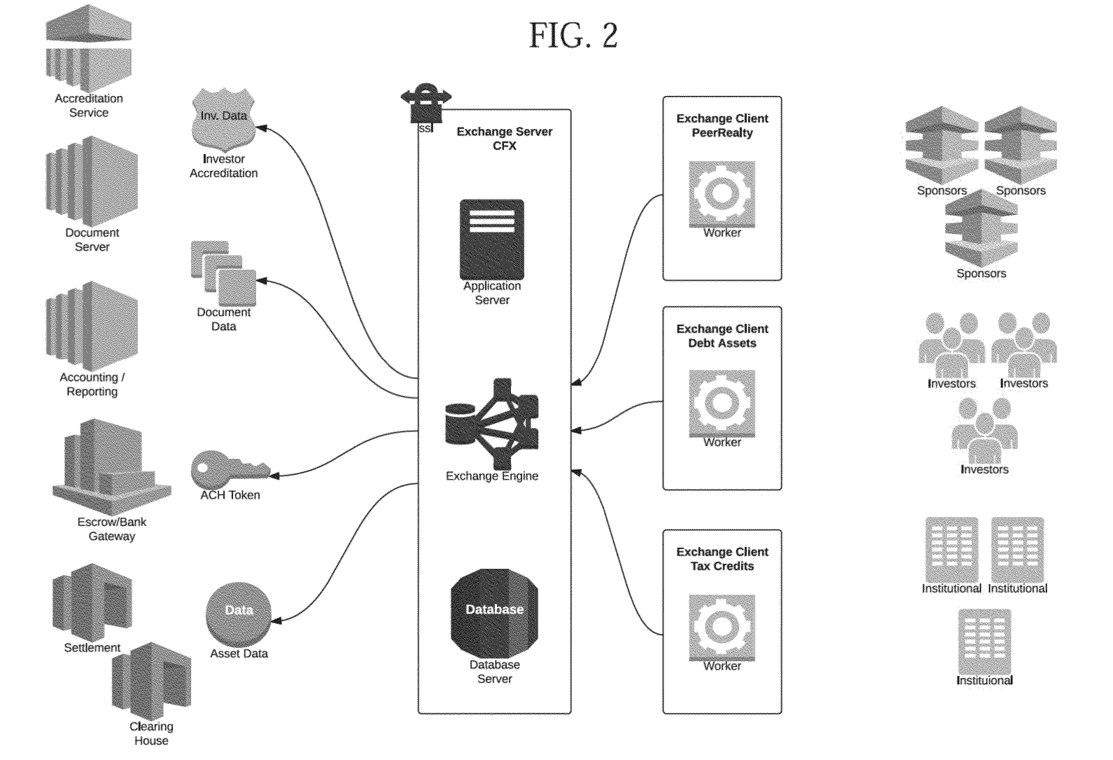

In an embodiment, as seen in FIGS. 1-2, the current invention is a system and computer-based method for trading and managing contracts issued via crowdfunding portals. The invention includes creating financial instruments for use by approved parties involving equity ownership, debt obligations or revenue sharing agreements of an underlying hard asset or business. The instruments are sold to approved and certified buyers who desire the contracts for ownership and economic interest. The intrinsic contract value is determined by the terms of the agreement and the revenue stream from the underlying asset, as well as by the time period remaining in the contract lifespan. The instruments can generate revenue and/or attribute book value to the current owner at the time of dividend yield or end of tax period. The computer-based trading system receives buy and sell orders for the derivative financial instruments from a plurality of client computers. The server computer matches the buy orders to the sell orders and manages ownership interest via an asset exchange and management program executed by the server computer.

The system manages disbursement of profits, dividends and other revenue to the contract owners via the asset exchange and management system.

### EXAMPLE

### Asset Exchange System & Asset Exchange Server

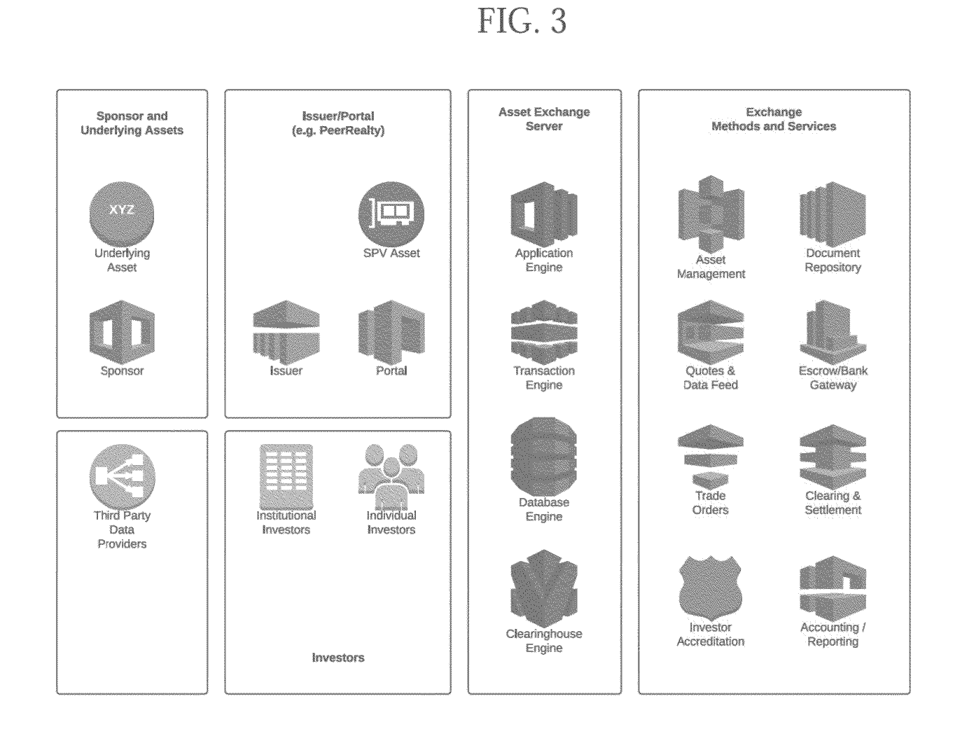

FIGS. 3 & 4A-4C depict an asset exchange system, according to an embodiment of the current invention. The asset exchange system provides a method for trading special purpose contracts of privately held assets, which defines the relationship among the involved parties and standardizes an interface, which allows for interoperability within the broader system and methodology. The asset exchange system operates on an asset exchange service, which facilitates and streamlines the process of trading standardized uniform data objects that represent illiquid private assets.

Referring specifically to FIG. 3, the players and entities involved within the asset exchange system involve the following: actors (sponsor, underlying asset, issuer); participants (portals, individual investors, institutional investors); object (CFA/SPV asset); asset exchange system—divisions (application interface, transaction matching, data storage, and payment, clearing & settlement); and asset exchange system—services (asset management (registration & listing), investor accreditation (registration & verification), quotes and data feed, trade orders), document repository (filing, archiving, signatures), escrow/bank getaway (payment processing), clearing & settlement (clearing of funds, settlement of assets), accounting/reporting). Within the network of the asset exchange system, the objects, systems, and methods involve the following: objects (sponsor (company account), underlying asset (data), issuer (company account)); participants (portals (registered exchange client), individual investors (investment account), institutional investors (investment account)); object (CFA/SPV asset (standardized data object)); asset exchange server—engines (application engine, transaction engine, database engine, clearinghouse engine); and asset exchange server—methods (asset management (registration & listing), investor accreditation (registration & verification), quotes and data feed, trade orders, document repository (filing, archiving, signatures escrow/bank getaway (payment processing), clearing & settlement (clearing of funds, settlement of assets), accounting/reporting). Other suitable objects and participants are contemplated herein as well for use in the asset exchange system and server.

More specifically, the sponsor is typically an asset management company or development company that owns/manages the underlying asset. Sponsors can be defined as “Company Accounts” within the asset exchange server.

The underlying asset can be a wide variety of assets with a definable enterprise value and revenue stream. Examples include, but are not limited to, real estate property, private held companies and investment funds, among other suitable assets. Within the asset exchange server, underlying assets can be codified as general data tied to the CFA/SPV asset data object.

The issuer typically is a broker dealer or registered rep that sources investment opportunities, conducts due diligence, and finally promotes the private offerings to an audience of accredited investors, Issuers can be defined as “company accounts” within the asset exchange server.

Portals typically are operated by issuers and are the public platform by which investors can access the asset exchange system. Portals should be registered and authenticated with the system. Portals can be registered as clients within the asset exchange server. Investors may not be able to access the asset exchange server directly without the use of an intermediary. Alternatively, it is contemplated herein that investors may go directly to an exchange rather than using portals as intermediaries.

Investors typically are individual accredited investors (depending on and subject to change based on SEC regulations), corporate investment entities or institutional level investment firms. Investors can be defined as “investment accounts” within the asset exchange server.

The issuer identifies sponsors who are currently seeking capital for the underlying assets and structures an agreement whereas a CFA/SPV is created to allow for the placement of private capital from a multitude of investors in exchange for a defined level of economic interest within the underlying asset. This will become clearer as this specification continues.

### CFA/SPV Asset & CFA/SPV Asset Data Object

The special purpose vehicle (SPV) or crowd-funded asset (CFA), which can be used interchangeably with one another, is typically structured as a series LLC (or other corporate structure) managed by the issuer (e.g., PEEREALTY or other crowdfunding platform). The CFA is a standardized object that has three parties: the issuer, a sponsor who owns/manages an underlying hard asset, and an aggregated group of investors who enter as members.

The CFA defines the relationship among the involved parties and standardizes an interface which allows for interoperability within the broader system and mechanism. As a data object, the CFA has a defined level of economic interest in the underlying asset, This total level of economic interest is predetermined by the sponsor and issuer, and is largely driven by the sponsor's needs for capital raise. The terms around the economic interest are driven primarily by existing terms of current private offers in the underlying asset, but can be altered per the negotiations and agreement between the sponsor and the issuer. There is a defined membership interest in the CFA for investor participants to purchase. The number of the CFA shares available are determined at time of creation by the issuer. There is also a defined initial value of membership interest shares in the CFA. This initial value of the CFA shares are determined at the time of creation by the issuer. The value of the CFA shares times the number of CFA shares equals the total value of economic interest in underlying asset (minus legal costs and management fees). The CFA can further have a term length of the instrument (tied to the underlying asset). The CFA can include distribution rights of economic returns and a defined schedule (tied to the underlying asset), along with terms to determine ownership and distribution eligibility (e.g., ex dividend dates) (defined by the issuer for the CFA) and transfer restrictions (if any) (issuer approval, timeframe restriction, approved mediums) (defined by the issuer for the CFA).

Further, as a data object, the CFA can include a range of methodologies, including, but not limited to, the issuer offer, member purchase, member transfer, distribution of profits or returns, ownership determination, valuation methods, etc.

The CFA can additionally have data variables (stored within the exchange server database engine). The variables include, but are not limited to, membership table (current and past); membership ownership—amount of shares and date of ownership (current and past); history of member purchase and transfers, including share price and dates; accumulated undistributed profits or returns to members; history of distributed returns to members; pointer to cloud-based document repository for CFA documents; pointer to escrow account for CFA transactions; and pointer to investment/company accounts for the issuer and the sponsor.

The object properties of the CFA can be defined on an asset-by-asset basis by an agreement between the issuer and the sponsor. The properties are negotiated and explicitly disclosed to the public and participants. The system allows for each CFA to be serialized as a data object that can easily be transmitted to interested parties over standard internet protocols, for example through the provided use of a REST based application program interface (API). This method is provided by the application engine within the asset exchange server, which will become clearer as this specification continues.

Upon creation of the CFA, the asset is ready to be loaded into the asset exchange system and offered to the public. Legal documents are collected and placed in a centralized location. An escrow account is created to store the funds for the offer. The asset is prepared to begin receiving private capital from accredited investors (individuals permitted under SEC regulations for Reg D private placements) (subject to changes in SEC regulations and other laws, as unaccredited investors may be allowed and are contemplated by the current invention). This will become clearer as this specification continues. Within the asset exchange server, the CFA is ready to be loaded onto the exchange offers. A new investment account is created for the sponsor and issuer (if one does not already exist). Every company account is reviewed and screened to ensure quality participants. Background checks and AML reports are run on company entities. A new cloud-based document repository is created specifically for the new asset. Necessary documents for the issuance of private securities are gathered and stored within this repository. Required documents include an operating agreement, and a PPM a subscription. Once the legal documents have been collected, reviewed, and placed within the document repository, a new escrow account is initiated. An escrow agreement is signed with the Issuer and sponsor completing the process. The CFA is managed by the asset exchange manager that maintains its state and data consistency across the exchange servers. The CFA asset has its data variables initiated and the pointers to the document repository, escrow account, and Investment Accounts are set per the creation process. The foregoing steps will become clearer as this specification continues.

### Asset Exchange System—Divisions & Asset Exchange Server—Engines

The asset exchange system is comprised of various divisions that provide the infrastructure for the provided services. Similarly, the Asset Exchange Server is comprised of various engines that provide the infrastructure for the provided methods of the server.

The application interface division in the system provides a standardized public interface that allows for secure communication with the asset exchange system. Typically, communications with the asset exchange system run through the application interface division. The application engine within the server provides the standardized entry point in the asset exchange server via an API. Typically, calls to and from the server pass through this authenticated point, which calls for the user of public and private keys to authenticate and authorize clients to the server.

The transaction matching division in the system provides the capabilities to match buy and sell offers within the asset exchange system. The transaction engine within the server is an object matching engine. Buy and sell orders that are placed via the application engine are entered into order book storage units. The transaction engine then manages and matches order objects using a matching algorithm with price-time priority.

The data storage division in the system stores the transaction data that resides within the asset exchange system. The database engine within the server is an object-relational database management system used to store data securely, retrieve data remotely and operate within a large-scale computer cluster.

The payment, clearing and settlement division in the system ensures the proper clearing of funds and settlement of asset ownership within the asset exchange system. The clearinghouse engine within the server encapsulates the mechanisms to do payment processing, secure document and signature management, clearing of funds and settlement of assets.

### Asset Exchange System—Services & Asset Exchange Server—Methods

The asset exchange system provides services/methods, as follows: asset management (registration & listing), investor accreditation (registration & verification), quotes and data feed, trade orders, document repository (filing, archiving, signatures), escrow/bank gateway (payment processing), clearing & settlement (clearing of funds, settlement of assets), and accounting/reporting. The asset exchange server provides services/methods, as follows: asset management (registration & listing), investor accreditation (registration & verification), quotes and data feed, trade orders, document repository (filing, archiving, signatures), escrow/bank gateway (payment processing), clearing & settlement (clearing of funds, settlement of assets), and accounting/reporting.

### Asset Management (Registration & Listing)

Within the asset exchange system, asset management is handled by the application interface division and the asset management service. Within the asset exchange server, asset management is handled by the application engine and the asset management method.

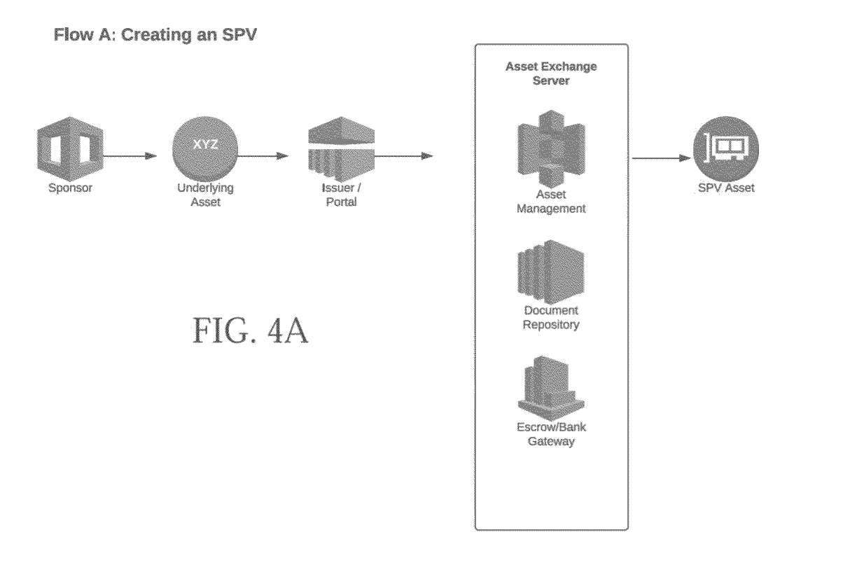

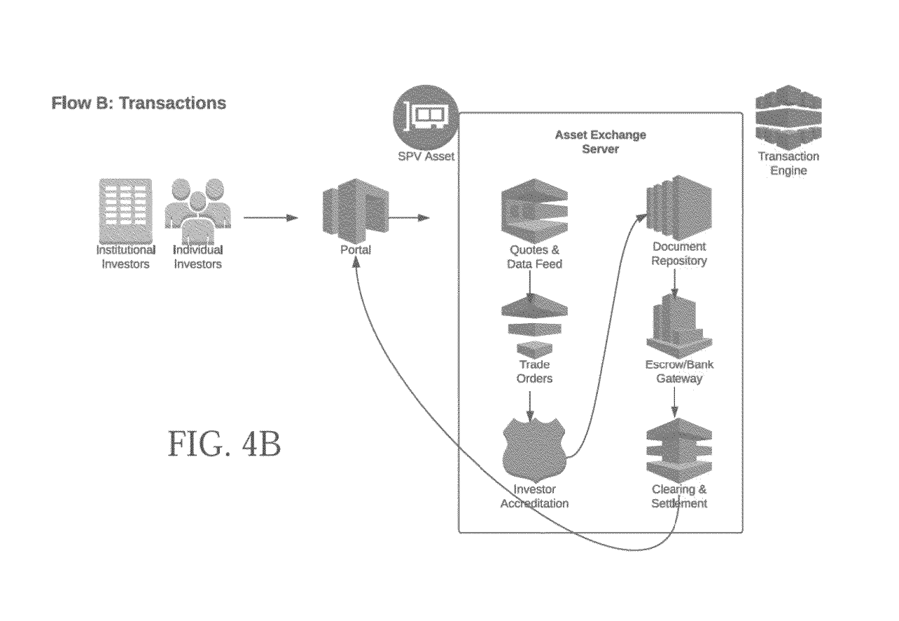

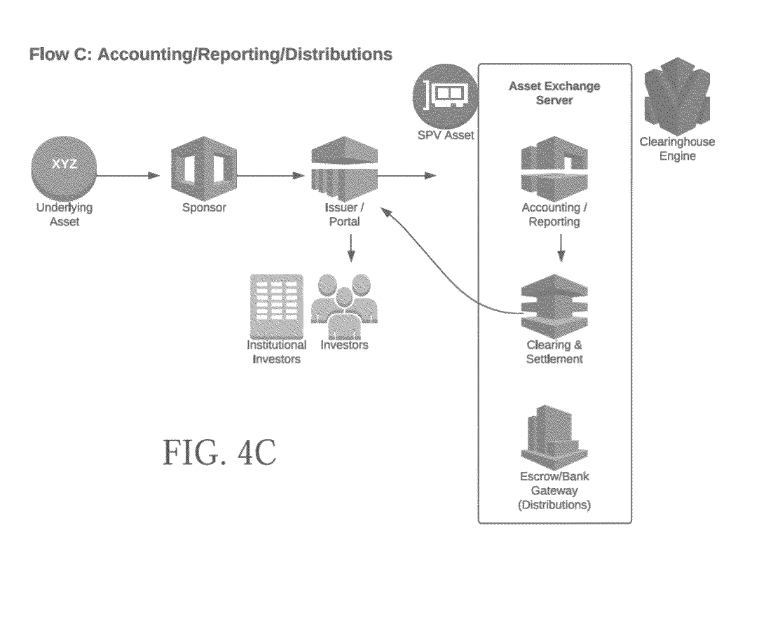

Now referring to FIG. 4A, an issuer identifies sponsors who are currently seeking capital for underlying assets and structures an agreement whereas a CFA is created to allow for the placement of private capital from a multitude of investors in exchange for a defined level of economic interest within the underlying asset.

W hen the terms of the CFA have been defined, the issuer registers the CFA asset with the asset exchange system. Legal documents are collected and placed in a centralized document location within the asset exchange system. An escrow account is created to store the funds for the offer. The asset is prepared to begin receiving private capital from accredited investors (individuals permitted under SEC regulations for Reg D private placements) (subject to changes in SEC regulations and other laws, as unaccredited investors may be allowed and are contemplated by the current invention).

Within the asset exchange server, when the terms of the CFA have been defined, the CFA object is created and registered in the exchange server. A new company account is created for the sponsor and issuer (if one does not already exist). Every company account is reviewed and screened to ensure quality participants. Background checks and AML reports are run on company entities.

A new document repository is created using the clearinghouse engine specifically for the new asset. Necessary documents for the issuance of private securities are gathered and stored within this repository. Required documents include an operating agreement and a PPM a subscription. Once legal documents have been collected, reviewed, and placed within the document repository, a new escrow account is initiated via the clearinghouse engine. An escrow agreement is signed with the issuer and sponsor completing the process.

The CFA is managed by the transaction engine, which maintains its state and data consistency in the database engine. The CFA asset has its data variables initiated and the pointers to the document repository, escrow account, and investment accounts are set per the creation process.

Within the asset exchange system, the CFA is offered via the issuer's broker dealer affiliation to the general public via a registered portal, although only accredited investors (individuals permitted under SEC regulations for Reg D private placements) can participate in the process. It is contemplated herein, however, that other types of accredited investors or unaccredited investors can participate in the process, subject to changes in SEC regulations and other laws. Accredited investors participate on the exchange through the use of a registered portal. Portals are typically run by issuers and affiliates.

The portal lists the investment offerings and conducts the necessary registration, accreditation verification (subject to changes in SEC regulations), bank account linking or margin account management, and finally the initiation of the transaction that allows for accredited investors to participate on the exchange. The portal also provides tracking and performance reports for assets that are in an accredited investor's portfolio.

### Investor Accreditation—Registration & Verification

Investor accreditation can be handled in the asset exchange system by the interface division, and it is handled in the asset exchange server by the application engine. The asset exchange system provides the mechanism to create new investment accounts and verify their investor suitability and accreditation status. It should be noted, though, that the standard of accreditation, or even presence thereof is subject to change based on changes in laws. Accredited investors participate on the exchange by signing up via a registered portal. The portal lists the investment offerings and conducts basic user registration. The portal then allows the investors to create an investment account and verify their status via series provided by the application interface.

The application engine within the asset exchange server provides a methodology for allowing the creation of new investment accounts, verification of investor suitability, and performance of an accreditation process on the investor. Portals (clients to the server) can make calls to the application engine via an API.

When an investment account is created in the asset exchange system, the server receives completed data fields pertaining to the particular individual or company, for example account type (individual or company), account name (entity's legal name), tax identification number (social security number or FEIN for entity), account email (entity's contact email), legal contact information (address, city, state, zip code, phone number), date of birth (for an individual), executive name (person executing legal documents, for a company), and state of formation (for a company).

Investor accreditation can be verified in the asset exchange system, for example via an investor suitability questionnaire and/or documentation to support answers in the questionnaire. In the asset exchange server, the investor can input information in appropriate data fields, such as net worth, household income (for the past two years), exemptions as an officer or manager of an investment firm, and/or necessary documentation to support the foregoing data fields (stored in document repository).

### Quotes and Data Feed

Quotes and data feed can be handled in the asset exchange system by the quotes and data feed service through the application interface division. Quotes and data feed can be handled in the asset exchange server by the quotes and data feed method through the application engine (published via the server API). The system allows for the viewing of listed assets within the system along with latest price quotes and order book display, and the server allows for a data feed of listed assets within the server along with real-time price quotes and detailed order book display (to select clients).

### Trade Order—Purchase Orders Initial Offers

Trade orders can be handled in the asset exchange system by the transaction matching division and the trade orders service. Trade orders can be handled in the asset exchange server by the transaction engine and the trade orders method. Purchase orders and buy/sell orders will become clearer as this specification continues.

Referring specifically to FIG. 4B, to initiate a successful transaction in the system, the following steps may be taken. An investor reviews CFA asset listings within a registered portal. An investor decides to place a purchase order for a listed CFA asset after reviewing the accompanying information. This initiates the “trade order” service within the system which requires additional items (listed below) in order to initiate a successful transaction. The system verities their investor account and suitability status, and if found lacking, will require the investor to run through the investor accreditation process (subject to change, per SEC regulations). The system presents investment documents from the document repository that will need to be signed electronically. The system then seeks approval and authorization for an ACH transfer to submit the transaction. The transaction is submitted and accepted by the system, Upon successful submission of a transaction request, the clearing and settlement process can be conducted to ensure that funds are cleared and that documents are reviewed. The investor is notified of a successful transaction resulting in a completed trade order.

Within the asset exchange server, the transaction engine is an object matching engine. Buy/Purchase and sell orders that are placed through the application engine are entered into order book storage units. The transaction engine then manages and matches order objects using a matching algorithm with price-time priority.

### Document Repository (Filing, Archiving, Signatures)

The document repository is handled in the asset exchange system by the payment, clearing, and settlement division, and it is handled within the asset exchange server by the clearinghouse engine. The document repository provides a secure and authenticated format to store legal documents and files that are associated with CFA assets, investor accreditation process, trade orders, escrow agreements, clearing and settlement process, and accounting/reporting process. The document repository method assigns an anonymous document key token to the different documents and files within the server to allow for a secure transfer of documents.

### Escrow/Bank Gateway (Payment Processing)

The escrow/bank gateway can be handled by the payment, clearing, & settlement division in the asset exchange system, and it can be handled by the clearinghouse engine in the asset exchange server. In the system, the escrow/bank gateway service handles the electronic transfer of funds from a bank account or margin account and stores it within a specialized escrow account until it is ready to be moved to its final destination. In the server, the escrow/bank gateway method assigns an anonymous vault token to the different bank/margin accounts called by the server, and anonymous payment tokens to the actual financial transactions that take place within the server.

### Clearing & Settlement

Clearing and settlement can be handled by the payment, clearing, & settlement division in the asset exchange system, and it can be handled by the clearinghouse engine in the asset exchange server. The clearing and settlement service handles the process of ensuring that funds have been cleared (from the escrow/payment gateway) and reviewing documents within the document repository for trade orders placed within the system.

Further, the clearing and settlement service handles the membership table for CFA assets and investors. When accounting/reporting/distributions are sent into the system, the clearing and settlement service ensures proper delivery to the appropriate investors who participated as members within a CFA asset within the specified reporting period.

### Accounting/Reporting

Accounting and reporting can be handled by the payment, clearing, & settlement division in the asset exchange system, and it can be handled by the clearinghouse engine in the asset exchange server. Referring specifically to FIG. 4C, the flow of accounting/reporting within the system can take place as follows. The data and performance of the underlying asset is assessed by the sponsor (can be done every month, quarter, or year per the CFA asset agreement), The sponsor provides data around the underlying asset to the issuer and/or portal (as defined in terms of CFA asset agreement). The portal submits notification of the data to the asset exchange system. The system routes the data to the accounting/reporting service. The clearing and settlement service determines which investors should receive notification of data based on the CFA asset's member table. The system notifies the portal of which investors need to be provided the incoming data.

### Distributions

Accounting and reporting can be handled in the asset exchange system by the payment, clearing, & settlement division, and it can be handled in the asset exchange server by the clearinghouse engine. Still referring to FIG. 4C, the flow of the distribution process within the system can take place as follows. The underlying asset releases distributions (cash dividends, debt repayments, equity sales, etc.), as managed by the sponsor and schedule by the terms of the CFA asset agreement. The sponsor provides the distributions to the issuer and/or portal (as defined in terms of CFA asset agreement). The portal places the distributions into escrow (if required by law) and submits notification of available distributions to the asset exchange system. If distributions are required to be placed in escrow, the distributions would be routed through the escrow/bank gateway service. The system routes the distribution data to the accounting/reporting service. The clearing and settlement service determines which Investors should receive notification and allocation of the distributions based on the CFA asset's member table. The system notifies the portal of which investors need to be provided with the incoming distributions.

During this distribution process in the system, the asset exchange server provides for an asset profits/returns mechanism and associated methodologies.

### Buy/Sell

The buy/sell orders can be handled in the asset exchange system by the transaction matching division and the trade orders service. They can be handled in the asset exchange server by the transaction engine and trade orders method. Purchase orders for an initial offer have been described herein previously. Referring back to FIG. 4B, the following steps may be taken to initiate a successful transaction. An investor reviews CFA asset listings and price quotes within a registered Portal. Investors can see bids and asks from the order book mechanism within the system. Subsequently, an investor decides to buy or sell a listed CFA asset after reviewing the accompanying information. This initiates the “trade order” service within the system, which requires additional items (listed below) in order to initiate a successful transaction. Buyers are making a purchase order in the CFA asset, and sellers require that the system verify ownership of the CFA asset in the name of the investor. This process is handled by the clearing and settlement service, which maintains the member table for each CFA asset.

The system then verifies their investor account and suitability status, and if found lacking, will require the investor to run through the investor accreditation process (subject to change, per SEC regulations). Participants should pass the investor accreditation again, perhaps even if they had previously passed during their earlier purchase order (e.g., a seller should still pass accreditation). The system presents investment documents from the document repository that are to be signed electronically. Buyers are signing purchase order documents to gain member interest in the CFA asset, and sellers are signing documents that authorize the transfer of member interest in the CFA asset to another participant. The system then seeks approval and authorization for an ACH transfer to submit the transaction. Buyers are providing funds for the purchase order, and sellers are indicating where they would like to receive funds for their transfer order. Funds are held in escrow until a match has been found.

At this point, a buy order and a sell order should match prior to the following steps taking place. When the buy order and the sell order match, the transaction is submitted and accepted by the system. Upon successful submission of a transaction request, the clearing and settlement process is conducted to ensure that funds are cleared and that documents are reviewed. Orders remain pending until buyer funds have cleared, and purchase and transfer documents have been reviewed. Orders are finalized when the clearing and settlement service has transferred membership interest in the CFA asset.

Upon finalization/completion of the order/transaction, the investors are notified of a successful transaction resulting in a completed trade order.

Within the asset exchange server, the transaction engine is an object matching engine. Buy/Purchase and sell orders that are placed via the application engine are entered into order book storage units. The transaction engine then manages and matches order objects using a matching algorithm with price-time priority.

### Hardware and Software Infrastructure Examples

The present invention may be embodied on various computing platforms that perform actions responsive to software-based instructions and most particularly on touchscreen portable devices, The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++, Visual Basic or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that when referenced, an “end-user” is an operator of the software as opposed to a developer or author who modifies the underlying source code of the software. For security purposes, authentication means identifying the particular user while authorization defines what procedures and functions that user is permitted to execute.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A computer-implemented method, comprising:
providing/receiving an asset exchange system;
receiving a special purpose vehicle/contract from an issuer, said special purpose vehicle/contract covering a privately held asset from a sponsor;
authenticating said sponsor and creating a company account for said sponsor and said issuer;
said asset exchange system used for trading said special purpose vehicle/contract of said privately held asset, said asset exchange system operating on an asset exchange server that facilitates trading of standardized uniform data objects that represent illiquid private assets,
said asset defining a relationship between a sponsor thereof, an issuer thereof, and an investor thereof and standardizes an Internet-based interface for use by said sponsor, said issuer, and said investor,
said asset being a crowd funded asset and having a definable enterprise value and revenue stream, said asset having economic interest received from said sponsor, wherein said economic interest is determined by a need of said sponsor to raise capital,
said private held asset also having a term length, distribution rights of economic returns, a defined schedule, and terms to determine ownership and distribution eligibility, and transfer restrictions;
receiving a total value of said privately held asset divided into a number of shares issued by an issuer;
creating a document repository for storing documents relevant to said asset and to said special purpose vehicle/contract, such as legal documents and securities documents;
initiating a new escrow account based on said special purpose vehicle/contract and said privately held asset;
authenticating a plurality of institutional investors and/or individual investors on said asset exchange system;
in response to receiving a trade order from said investor, creating an investor, account for said investor, verifying suitability of said investor, and performing an accreditation process on said investor, if found to be unsuitable,
said asset exchange system having a transaction matching module for matching buy offers and sell offers within said asset exchange system,
said asset exchange system further having a data storage module for storing transaction data within said asset exchange system,
said asset exchange system having a payment, clearing and settlement module for ensuring proper clearing of funds and settlement of asset ownership within said asset exchange system;
initiating a transaction between said sponsor, said issuer, and each investor found to be suitable;
receiving approval from said sponsor or said issuer for said trade order, said transaction matching module matching the buy order and the sell order;
completing said transaction; and
performing obligations per said special purpose vehicle/contract.

2. One or more tangible non-transitory computer-readable media having computer-executable instructions for performing a method of running a software program on a computing device, the computing device operating under an operating system, the method including issuing instructions from the software program, the method comprising:
providing/receiving an asset exchange system;
receiving a special purpose vehicle/contract from an issuer, said special purpose vehicle/contract covering a privately held asset from a sponsor;
authenticating said sponsor and creating a company account for said sponsor and said issuer;
said asset exchange system used for trading said special purpose vehicle/contract of said privately held asset, said asset exchange system operating on an asset exchange server that facilitates trading of standardized uniform data objects that represent illiquid private assets,
said asset defining a relationship between a sponsor thereof, an issuer thereof, and an investor thereof and standardizes an :Internet-based interface for use by said sponsor, said issuer, and said investor,
said asset being a crowd funded asset and having a definable enterprise value and revenue stream, said asset having economic interest received from said sponsor, wherein said economic interest is determined by a need of said sponsor to raise capital,
said private held asset also having a term length, distribution rights of economic returns, a defined schedule, and terms to determine ownership and distribution eligibility, and transfer restrictions;
receiving a total value of said privately held asset divided into a number of shares issued by an issuer;
creating a document repository for storing documents relevant to said asset and to said special purpose vehicle/contract, such as legal documents and securities documents;
initiating a new escrow account based on said special purpose vehicle/contract and said privately held asset;
authenticating a plurality of institutional investors and/or individual investors on said asset exchange system;
in response to receiving a trade order from said investor, creating an investor account for said investor, verifying suitability of said investor, and performing an accreditation process on said investor if found to be unsuitable,
said asset exchange system having a transaction matching module for matching buy offers and sell offers within said asset exchange system,
said asset exchange system further having a data storage module for storing transaction data within said asset exchange system,
said asset exchange system having a payment, clearing and settlement module for ensuring proper clearing of funds and settlement of asset ownership within said asset exchange system;
initiating a transaction between said sponsor, said issuer, and each investor found to be suitable;
receiving approval from said sponsor or said issuer for said trade order, completing said transaction; and
performing obligations per said special purpose vehicle/contract.

3. An asset exchange system used for trading a special purpose vehicle/contract of a privately held asset, where said special purpose vehicle/contract is issued by an issuer and said privately held asset is owned by a sponsor, the system comprising:
a seller authentication module for authenticating said sponsor and creating a company account for said sponsor and said issuer,
said asset exchange system operating on an asset exchange server that facilitates trading of standardized uniform data objects that represent illiquid private assets,
said asset defining a relationship between a sponsor thereof an issuer thereof, and an investor thereof and standardizes an :Internet-based interface for use by said sponsor, said issuer, and said investor,
said asset being a crowd funded asset and having a definable enterprise value and revenue stream, said asset having economic interest received from said sponsor, wherein said economic interest is determined by a need of said sponsor to raise capital;
a term length, distribution rights of economic returns, a defined schedule, and terms to determine ownership and distribution eligibility, and transfer restrictions,
wherein said issuer issued a total value of said privately held asset divided into a number of shares;
a document repository for storing documents relevant to said asset and to said special purpose vehicle/contract, such as legal documents and securities documents,
wherein a new escrow account based on said special purpose contract and said privately held asset;
a buyer authentication module for authenticating a plurality of institutional investors and/or individual investors on said asset exchange system;
wherein in response to receiving a trade order from said investor, an investor account is created for said investor;
a verification module for verifying suitability of said investor;
an accreditation module for performing an accreditation process on said investor if found to be unsuitable;
a transaction matching module for matching buy offers and sell offers within said asset exchange system;
a data storage module for storing transaction data within said asset exchange system; and
a payment, clearing and settlement module for ensuring proper clearing of funds and settlement of asset ownership within said asset exchange system,
wherein a transaction is initiated between said sponsor, said issuer, and each investor found to be suitable and when approval from said sponsor or said issuer is received for said trade order, said transaction matching module matches the buy order and the sell order in order to complete said transaction.
